(19) United States
(12) Patent Application Publication
(10) Pub. No.: US 2009/0262840 A1
(43) Pub. Date: Oct. 22, 2009

(54) Synchronization Signal Extraction Device and Related Method

(76) Inventors: Chung-Jr Jan, Taipei County (TW); Shang-Hsiu Wu, Hsinchu County (TW); Kuo-Chi Chen, Hsinchu County (TW); Ying-Jie Su, Hsinchu City (TW); Po-Jui Huang, Hsinchu County (TW); Chien-Cheng Tu, Hsinchu City (TW); Po-Ju Lee, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/181,325

(22) Filed: Jul. 29, 2008

(30) Foreign Application Priority Data
Apr. 22, 2008 (TW) 097114644

(51) Int. Cl. H04N 7/26

(52) U.S. Cl. 375/240.28; 375/E07.026

(57) ABSTRACT

A synchronization signal extraction device includes a signal reception terminal for receiving a composite video signal, a threshold voltage adjuster coupled to the signal reception terminal for adjusting a threshold voltage to a ratio of a first characteristic level and a second characteristic level of the composite video signal according to the first characteristic level and the second characteristic level, a slicer coupled to the signal reception terminal and the threshold voltage adjuster for slicing the composite video signal to extract a synchronization signal in the composite video signal, and a signal output terminal coupled to the slicer for outputting the extracted synchronization signal.

### BACKGROUND OF THE INVENTION

1. Field of the Invention

The present invention relates to a synchronization signal extraction device and related method, and more particularly, to a synchronization signal extraction device and related method that dynamically adjusts a threshold voltage of a slicer to correctly extract a synchronization signal.

2. Description of the Prior Art

Generally, a synchronization signal is used for a display to correctly handle and display received video signals. In some video transmission interfaces, the synchronization signal is carried in a certain video signal for transmission. For example, when inputs of the display are RGB signals, the synchronization signal can be carried in a G signal of the RGB signals associated with a green color; and when the inputs of the display are YPbPr signals, the synchronization signal can be carried in a Y signal associated with luminance. The G signal carrying the synchronization signal is also referred to as an SOG signal (i.e. sync on G), and the Y signal carrying the synchronization signal is also referred to as an SOY signal (i.e. sync on Y). For convenience, these video signals are generally called composite video signals in the following.

Please refer to FIG. 1. FIG. 1 is a schematic diagram of a conventional composite video signal 10. As shown in FIG. 1, the composite video signal 10 is roughly divided into blocks 100, 110 and 120. The block 100 represents image data carried by the composite video signal 10, which can be data of a frame or a scan-line depending on time duration being represented. The block 110 is used as a reference level, or called as a black level, of the image data, by which the display is able to determine the image data correctly. The block 120 then represents a synchronization signal carried in the composite video signal 10, which can be a horizontal synchronization signal, a vertical synchronization signal or a composite synchronization signal formed by superposition of a horizontal synchronization signal and a vertical synchronization signal.

For the display capable of correctly handling and displaying the received video signals, an image processor generally utilizes a slicing circuit, called a slicer, to extract the synchronization signal carried in the composite video signal. Please refer to FIG. 2. FIG. 2 is a schematic diagram of a conventional slicer 20 utilized in an image processor. As shown in FIG. 2, the slicer 20 performs slicing operation on a received composite video signal SIN to extract a synchronization signal Sync according to a fixed threshold voltage TH1. However, due to instability of signal transmission, a DC level of the composite video signal may shift up and down as time varies, or may be mixed with too much noise during transmission. In this case, not only may the extracted synchronization signal shift along time, but the slicer 20 may also generate a wrong synchronization signal due to noise.

For example, please refer to FIG. 3, which illustrates how the slicer 20 extracts a synchronization signal when the DC level of the composite video signal shifts up and down along time. Apparently, as the DC level of the composite video signal SIN varies, the synchronization signal Sync extracted by the slicer 20 generates different durations on timing sequence, which may result in flickers on displayed images. On the other hand, please refer to FIG. 4, which illustrates how the slicer 20 extracts a synchronization signal when the DC level of the composite video signal is mixed with noise. As shown in FIG. 4, the synchronization signal Sync further includes a glitch when the noise is extracted by the slicer 20, which may also result in flickers on the displayed images.

In short, since the fixed threshold voltage is used to extract the synchronization signal in the prior art, when the DC level of the composite video signal varies or is mixed with too severe noise, the wrongly extracted synchronization signals may cause flickers on the displayed images.

### SUMMARY OF THE INVENTION

It is therefore an objective of the present invention to provide a synchronization signal extraction device and related method.

According to the present invention, a synchronization signal extraction device is disclosed. The synchronization signal extraction device includes a signal reception terminal, a threshold voltage adjuster, a slicer and a signal output terminal. The signal reception terminal is utilized for receiving a composite video signal. The threshold voltage adjuster is coupled to the signal reception terminal, and is utilized for adjusting a threshold voltage to a ratio of a first characteristic level and a second characteristic level of the composite video signal according to the first characteristic level and the second characteristic level. The slicer is coupled to the signal reception terminal and the threshold voltage adjuster, and is utilized for slicing the composite video signal to extract a synchronization signal in the composite video signal according to the threshold voltage. The signal output terminal is coupled to the slicer, and is utilized for outputting the extracted synchronization signal.

According to the present invention, a synchronization signal extraction method is further disclosed. The synchronization signal extraction method includes steps of receiving a composite video signal; adjusting a threshold voltage to a ratio of a first characteristic level and a second characteristic level of the composite video signal according to the first characteristic level and the second characteristic level; slicing the composite video signal to extract a synchronization signal in the composite video signal according to the threshold voltage; and outputting the extracted synchronization signal.

According to the present invention, a synchronization signal extraction device is further disclosed. The synchronization signal extraction device includes a signal reception terminal, a threshold voltage adjuster, a multiplexer, a slicer and a signal output terminal. The signal reception terminal is utilized for receiving a composite video signal. The threshold voltage adjuster is coupled to the signal reception terminal, and is utilized for outputting a threshold voltage according to a first characteristic level and a second characteristic level of the composite video signal, wherein the threshold voltage is a ratio of the first characteristic level and the second characteristic level. The multiplexer has a first input terminal coupled to the threshold voltage, a second input terminal coupled to a predetermined threshold voltage, and an output terminal, and is utilized for selectively outputting the threshold voltage or the predetermined threshold voltage via the output terminal. The slicer is coupled to the signal reception terminal and the output terminal of the multiplexer, and is utilized for slicing the composite video signal to extract a synchronization signal in the composite video signal according to the threshold voltage or the predetermined threshold voltage. The signal output terminal is coupled to the slicer, and is utilized for outputting the extracted synchronization signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional composite video signal.

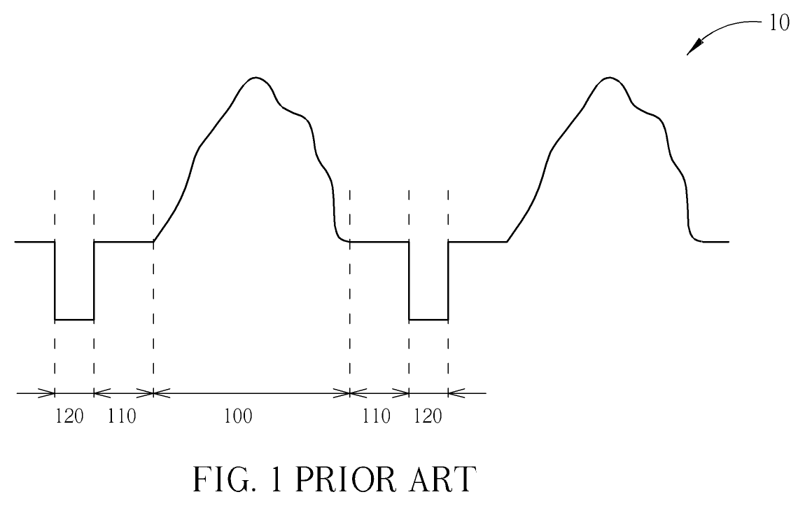

FIG. 2 is a schematic diagram of a conventional slicer utilized in an image processor.

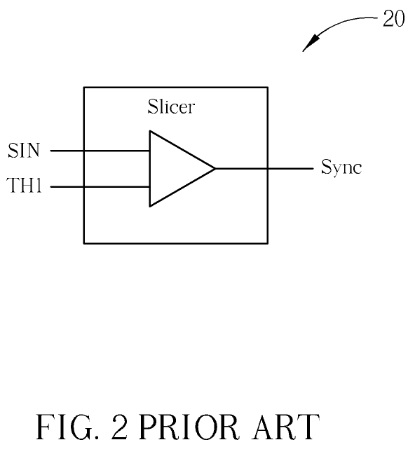

FIG. 3 illustrates how the slicer in FIG. 2 extracts a synchronization signal when a DC level of a composite video signal shifts up and down along time.

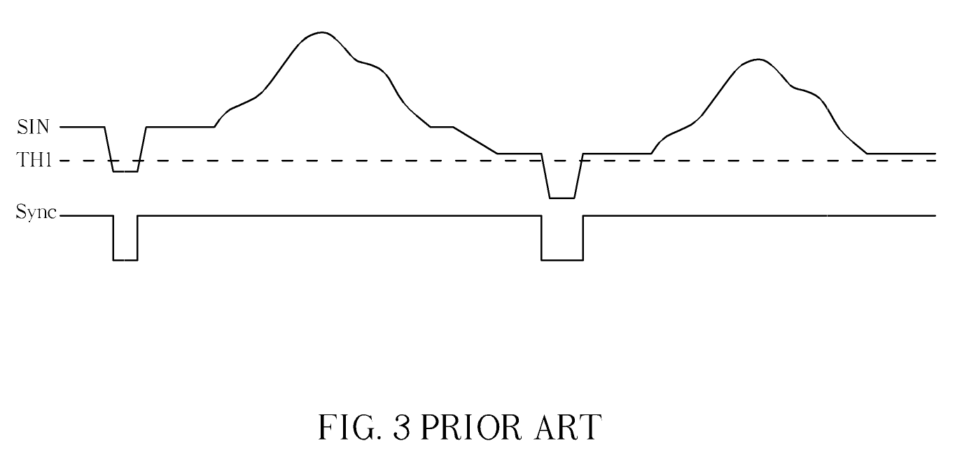

FIG. 4 illustrates how the slicer in FIG. 2 extracts a synchronization signal when a DC level of a composite video signal is mixed with noise.

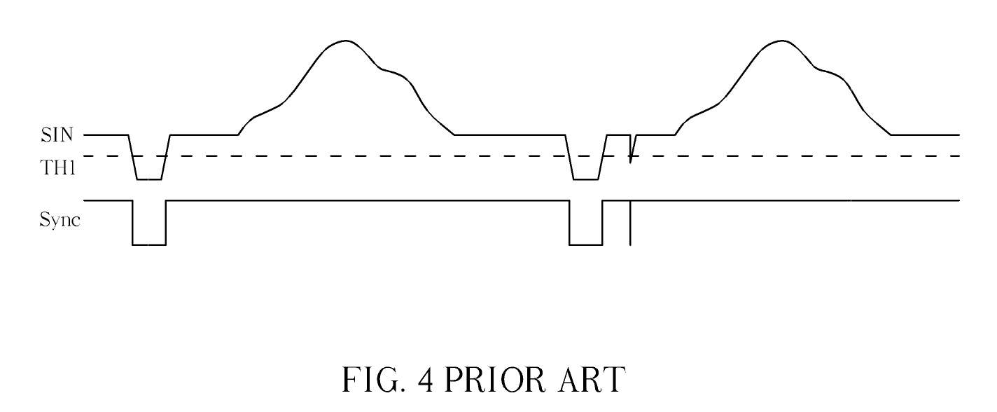

FIG. 5 is a schematic diagram of a synchronization signal extraction device of the present invention.

FIG. 6 is a schematic diagram of an embodiment of the threshold voltage adjuster in FIG. 5.

FIG. 7 is a schematic diagram of operating timing of the threshold voltage adjuster in FIG. 5.

FIG. 8 is a schematic diagram of another embodiment of the threshold voltage adjuster in FIG. 5.

FIG. 9 is a schematic diagram of a process for extracting a synchronization signal according to the present invention.

### DETAILED DESCRIPTION

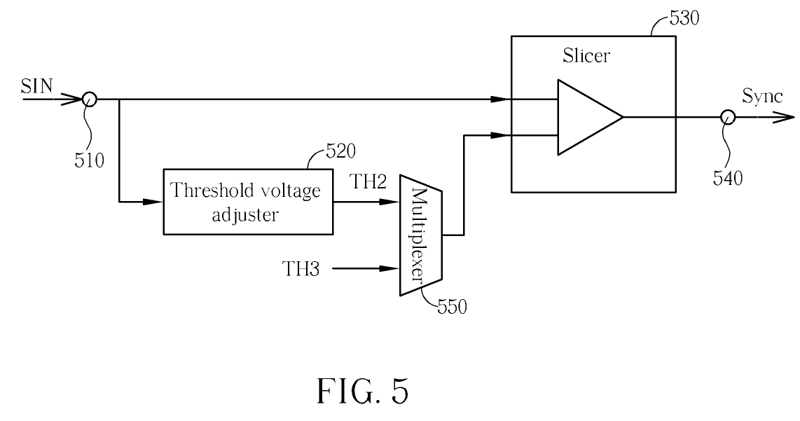

Please refer to FIG. 5. FIG. 5 is a schematic diagram of a synchronization signal extraction device 50 of the present invention. The synchronization signal extraction device 50 is utilized for extracting a synchronization signal carried in a composite video signal, and includes a signal reception terminal 510, a threshold voltage adjuster 520, a slicer 530 and a signal output terminal 540. The signal reception terminal 510 is utilized for receiving a composite video signal SIN, which can be an SOG (Sync on G) signal or an SOY (sync on Y) signal. The threshold voltage adjuster 520 is coupled to the signal reception terminal 510, and is utilized for adjusting a threshold voltage TH2 to a ratio of a first characteristic level and a second characteristic level of the received composite video signal according to the first characteristic level and the second characteristic level. The slicer 530 is coupled to the signal reception terminal 510 and the threshold voltage adjuster 520, and is utilized for slicing the composite video signal to extract a synchronization signal Sync in the composite video signal according to the threshold voltage TH2. The signal output terminal 540 is coupled to the slicer 530, and is utilized for outputting the extracted synchronization signal Sync.

Therefore, in the synchronization signal extraction device of the present invention, the threshold voltage needed by the slicer is dynamically adjusted by detecting the characteristic levels of the composite video signal itself, so as to extract the synchronization signal correctly. In this case, when the DC level of the composite video signal varies or is mixed with too severe noise, the synchronization signal can still be correctly extracted according to the dynamically-adjusted threshold voltage, so that flickers on displayed images resulting from an incorrect extraction of the synchronization signals can be avoided.

Preferably, the synchronization signal extraction device 50 further includes a multiplexer 550, coupled between a predetermined threshold voltage TH3, the threshold voltage adjuster 520 and the slicer 530, for selectively coupling the threshold voltage adjuster 520 and the predetermined threshold voltage TH3 to the slicer 530. In this case, when the synchronization signal extraction device 50 is initiated, the predetermined threshold voltage TH3 can be used to extract the synchronization signal temporarily, and the threshold voltage adjuster 520 can then adjust the threshold voltage TH2 accordingly.

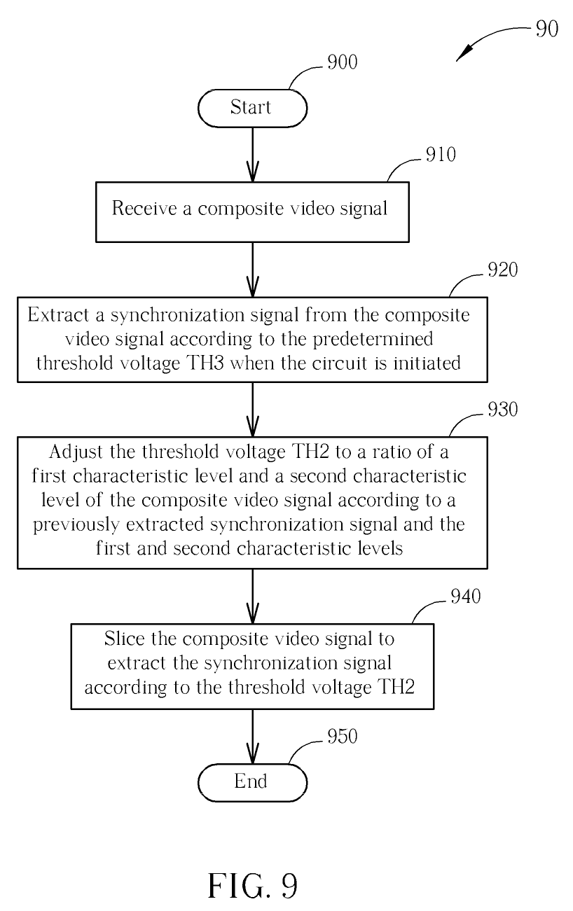

Please refer to FIG. 9. FIG. 9 is a schematic diagram of a process 90 of extracting a synchronization signal according to the present invention. The process 90 is utilized for implementing the synchronization signal extraction device 50, and includes the following steps:

Step 900: Start.

Step 910: Receive a composite video signal.

Step 920: Extract a synchronization signal from the composite video signal according to the predetermined threshold voltage TH3 when the circuit is initiated.

Step 930: Adjust the threshold voltage TH2 to a ratio of a first characteristic level and a second characteristic level of the composite video signal according to a previously extracted synchronization signal and the first and second characteristic levels.

Step 940: Slice the composite video signal to extract the synchronization signal according to the threshold voltage TH2.

Step 950: End.

According to the process 90, when the synchronization signal extraction device 50 is initiated, the predetermined threshold voltage TH3 is firstly used to extract the synchronization signal. Then, the slicer 530 is switched to couple to the threshold voltage adjuster 520 by the multiplexer 550, and thus the synchronization signal can be extracted according to the threshold voltage TH2 generated by the threshold voltage adjuster 520, in which the threshold voltage TH2 is adjusted to a ratio of the first characteristic level and the second characteristic level of the composite video signal according to a previously extracted synchronization signal and the first and second characteristic levels. Thus, the threshold voltage needed by the slicer can be dynamically adjusted according to the characteristic levels of the composite video signal itself, so that the synchronization signal can be extracted correctly. Detailed operations of the synchronization signal extraction device 50 are further illustrated in the following.

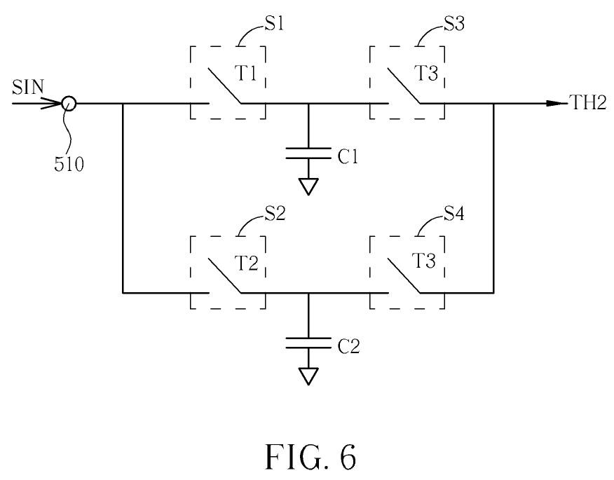

Please refer to FIG. 6, which is a schematic diagram of an embodiment of the threshold voltage adjuster 520. The threshold voltage adjuster 520 comprises sampling capacitors C1, C2 and switches S1-S4. The switch S1 is coupled between the signal reception terminal 510 and the sampling capacitor C1, and is utilized for coupling the sampling capacitor C1 to the signal reception terminal 510 during a first phase T1 to enable the sampling capacitor C1 to sample the first characteristic level. The switch S2 is coupled between the signal reception terminal 510 and the sampling capacitor C2, and is utilized for coupling the sampling capacitor C2 to the signal reception terminal 510 during a second phase T2 to enable the sampling capacitor C2 to sample the second characteristic level. The switches S3 and S4 are respectively coupled between the sampling capacitors C1, C2 and the slicer 530, and are utilized for performing charge sharing between the sampling capacitors C1 and C2 during a third phase T3 to output a ratio of the first characteristic level and the second characteristic level to the slicer 530 according to capacitances of the sampling capacitors C1 and C2. Preferably, relative timing of the first phase T1, the second phase T2 and the third phase T3 is determined according to a previously extracted synchronization signal, and the first characteristic level and the second characteristic level are respectively a lowest level of a synchronization signal interval and a black level of a video signal interval in the composite video signal, respectively.

In other words, after the relative timing of the first phase T1, the second phase T2 and the third phase T3 is determined according to a previously extracted synchronization signal, the threshold voltage adjuster 520 can then utilize the sampling capacitors C1 and C2 to sample the first characteristic level and the second characteristic level of the received composite video signal, and further output a ratio of the first characteristic level and the second characteristic level to the slicer 530 when charge sharing operation is performed according to capacitances of the sampling capacitors C1 and C2.

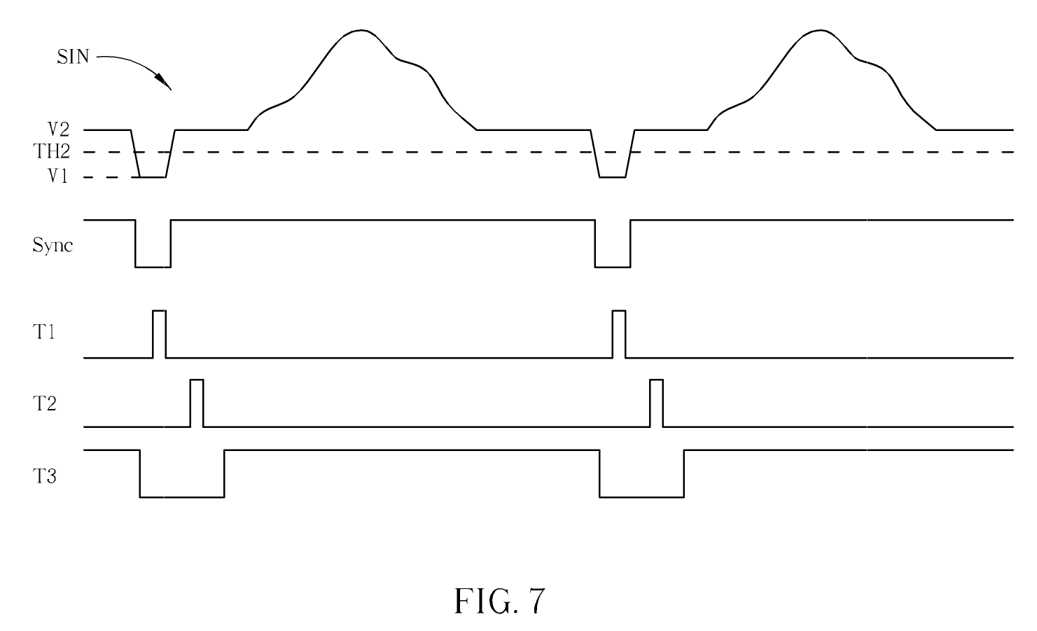

Please refer to FIG. 7, which is a schematic diagram of operating timing of the threshold voltage adjuster 520. In FIG. 7, SIN represents the composite video signal received by the synchronization signal extraction device 50; V1 and V2 respectively represent the lowest level of the synchronization signal interval and the black level of the video signal interval in the composite video signal; T1-T3 respectively represent the relative timing of the first phase, the second phase and the third phase, TH2 represents the threshold voltage outputted by the sampling capacitors C1 and C2 after the charge sharing is performed; and Sync represents the synchronization signal extracted by the slicer 530 according to the threshold voltage TH2. As shown in FIG. 7, the relative timing of the first phase T1, the second phase T2 and the third phase T3 is firstly determined by the threshold voltage adjuster 520 according to a previously extracted synchronization signal, wherein durations of the first phase and the second phase have to be long enough to completely charge the sampling capacitors C1 and C2, so as to enable sampled voltages of the sampling capacitors C1 and C2 equal to the lowest level V1 of the synchronization signal interval and the black level V2 of the video signal interval.

Then, the switches S3 and S4 are turned on during the third phase T3 to perform the charge sharing operation on the sampling capacitors C1 and C2, so the ratio of the first characteristic level V1 and the second characteristic level V2 are outputted to the slicer 530 according to the capacitances of the sampling capacitors C1 and C2. For example, when the capacitances of the sampling capacitors C1 and C2 are the same, a voltage outputted by the threshold voltage adjuster 520 is then equal to an average of the first characteristic level V1 and the second characteristic level V2, i.e. (V1+V2)/2, and further used as a new threshold voltage TH2 to extract the synchronization signal from the composite video signal.

Therefore, even if the DC level of the composite video signal shifts up and down as time varies, the synchronization signal can still be extracted correctly since the threshold voltage TH2 is dynamically adjusted according to the characteristic levels of the received composite video signal, so that the flickers of the displayed images can be avoided.

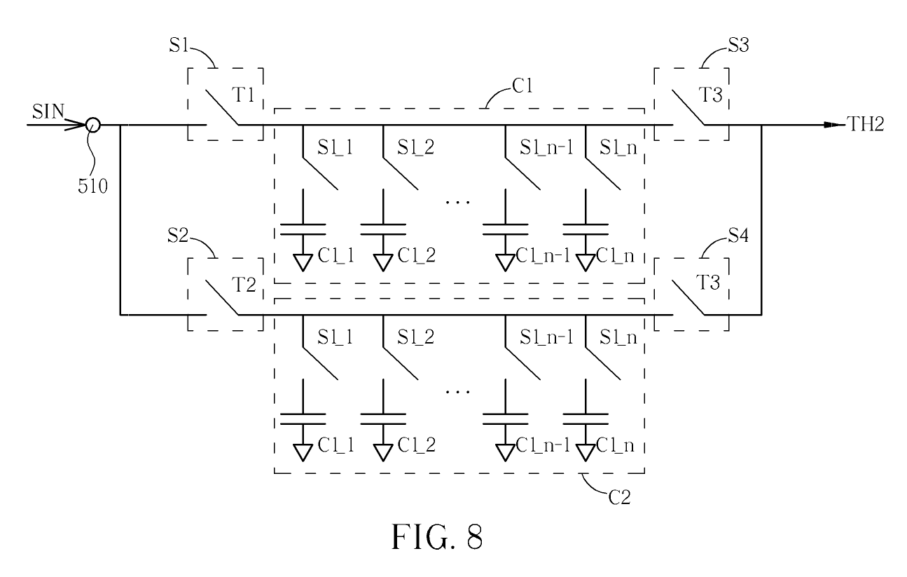

Please note that the above-mentioned threshold voltage adjuster is merely an exemplary illustration of the present invention, and those skilled in the art can certainly make appropriate modifications according to practical demands. For example, please refer to FIG. 8, which is a schematic diagram of another embodiment of the threshold voltage adjuster 520. Operation of the threshold voltage adjuster in FIG. 8 is similar to that in FIG. 6, but the difference is that the sampling capacitors C1 and C2 are composed of a plurality of parallel-connected capacitors, respectively. The plurality of parallel-connected capacitors are utilized for adjusting the capacitances of the sampling capacitors C1 and C2 through a plurality of switches, so that the outputted ratio of the first characteristic level V1 and the second characteristic level V2 can be further adjusted. In this case, when noise interference status is changed, the synchronization signal extraction device 50 can dynamically adjust the threshold voltage TH2 through switching the capacitances of the sampling capacitor C1 and C2, so that the present invention can prevent glitches from occurring in the extracted synchronization signal, which may result in the flickering of the displayed images.

As mentioned above, by detecting the characteristic levels of the composite video signal itself, the threshold voltage needed by the slicer can be dynamically adjusted to extract the synchronization signal in the present invention. Therefore, even if the DC level of the composite video signal shifts or is mixed with too severe noise, the synchronization signal can still be correctly extracted according to the dynamically-adjusted threshold voltage, so that the flickering of the displayed images resulting from a wrong extraction of the synchronization signal can be avoided.

Those skilled in the art will readily observe that numerous modifications and alterations of the device and method may be made while retaining the teachings of the invention.

What is claimed is:

1. A synchronization signal extraction device comprising:
a signal reception terminal for receiving a composite video signal; a threshold voltage adjuster, coupled to the signal reception terminal, for adjusting a threshold voltage to a ratio of a first characteristic level and a second characteristic level of the composite video signal according to the first characteristic level and the second characteristic level;
a slicer, coupled to the signal reception terminal and the threshold voltage adjuster, for slicing the composite video signal to extract a synchronization signal in the composite video signal according to the threshold voltage; and
a signal output terminal, coupled to the slicer, for outputting the extracted synchronization signal.

2. The synchronization signal extraction device of claim 1, wherein the composite video signal comprises a video signal interval and a synchronization signal interval for bearing a video signal and the synchronization signal, respectively.

3. The synchronization signal extraction device of claim 2, wherein the first characteristic level is a black level of the video signal interval.

4. The synchronization signal extraction device of claim 3, wherein the second characteristic level is a lowest level of the synchronization signal interval.

5. The synchronization signal extraction device of claim 2, wherein the first characteristic level is a lowest level of the synchronization signal interval.

6. The synchronization signal extraction device of claim 1, wherein the threshold voltage adjuster comprises:
a first sampling capacitor;
a second sampling capacitor;
a first switch, coupled between the signal reception terminal and the first sampling capacitor, for coupling the first sampling capacitor to the signal reception terminal during a first phase such that the first sampling capacitor samples the first characteristic level;
a second switch, coupled between the signal reception terminal and the second sampling capacitor, for coupling the second sampling capacitor to the signal reception terminal during a second phase such that the second sampling capacitor samples the second characteristic level;
a third switch, coupled between the first sampling capacitor and the slicer, for coupling the first sampling capacitor to the slicer during a third phase such that the first sampling capacitor outputs a sampled voltage to the slicer; and
a fourth switch, coupled between the second sampling capacitor and the slicer, for coupling the second sampling capacitor to the slicer during the third phase to enable the second sampling capacitor to output a sampled voltage to the slicer;
wherein the first sampling capacitor and the second sampling capacitor perform a charge sharing operation during the third phase to output the ratio of the first characteristic level and the second characteristic level to the slicer according to capacitances of the first sampling capacitor and the second sampling capacitor.

7. The synchronization signal extraction device of claim 6, wherein the first sampling capacitor and the second sampling capacitor individually comprise a plurality of parallel-connected capacitors, the capacitances of the first sampling capacitor and the second sampling capacitor being capable of adjusted by using a plurality of switches such that the outputted ratio of the first characteristic level and the second characteristic level is adjusted.

8. The synchronization signal extraction device of claim 6, wherein relative timing of the first phase, the second phase and the third phase is determined according to a previously-extracted synchronization signal.

9. The synchronization signal extraction device of claim 1, wherein the slicer further extracts a synchronization signal of the composite video signal according to a predetermined threshold voltage when the synchronization signal extraction device is initiated.

10. The synchronization signal extraction device of claim 9 further comprising a multiplexer, coupled to the threshold voltage adjuster, the predetermined threshold voltage and the slicer, for selectively coupling the threshold voltage adjuster and the predetermined threshold voltage to the slicer.

11. The synchronization signal extraction device of claim 1, wherein the composite video signal is an SOG (Sync On Green) signal.

12. The synchronization signal extraction device of claim 1, wherein the composite video signal is an SOY (Sync On Luma) signal.

13. A synchronization signal extraction method comprising:
receiving a composite video signal;
adjusting a threshold voltage to a ratio of a first characteristic level and a second characteristic level of the composite video signal according to the first characteristic level and the second characteristic level;
slicing the composite video signal to extract a synchronization signal in the composite video signal according to the threshold voltage; and
outputting the extracted synchronization signal.

14. The synchronization signal extraction method of claim 13, wherein the composite video signal comprises a video signal interval and a synchronization signal interval for carrying a video signal and the synchronization signal, respectively.

15. The synchronization signal extraction method of claim 14, wherein the first characteristic level is a black level of the video signal interval.

16. The synchronization signal extraction method of claim 15, wherein the second characteristic level is a lowest level of the synchronization signal interval.

17. The synchronization signal extraction method of claim 14, wherein the first characteristic level is a lowest level of the synchronization signal interval.

18. The synchronization signal extraction method of claim 13, wherein the step of adjusting the threshold voltage to the ratio of the first characteristic level and the second characteristic level of the composite video signal according to the first characteristic level and the second characteristic level comprises:
sampling the first characteristic level by a first sampling capacitor during a first phase;
sampling the second characteristic level by a second sampling capacitor during a second phase; and
performing a charge sharing operation between the first sampling capacitor and the second sampling capacitor during a third phase to output the ratio of the first characteristic level and the second characteristic level according to capacitances of the first sampling capacitor and the second sampling capacitor;
wherein relative timing of the first phase, the second phase and the third phase is determined according to a previously extracted synchronization signal.

19. The synchronization signal extraction method of claim 18 further comprising:
adjusting the capacitances of the first sampling capacitor and the second sampling capacitor through a plurality of switches for adjusting the outputted ratio of the first characteristic level and the second characteristic level.

20. The synchronization signal extraction method of claim 13 further comprising:
extracting a synchronization signal of the composite video signal according to a predetermined threshold voltage.

21. The synchronization signal extraction method of claim 13, wherein the composite video signal is an SOG (Sync On Green) signal.

22. The synchronization signal extraction method of claim 13, wherein the composite video signal is an SOY (Sync On Luma) signal.

23. A synchronization signal extraction device comprising:
a signal reception terminal for receiving a composite video signal;
a threshold voltage adjuster, coupled to the signal reception terminal, for outputting a threshold voltage according to a first characteristic level and a second characteristic level of the composite video signal, wherein the threshold voltage is a ratio of the first characteristic level and the second characteristic level;
a multiplexer, having a first input terminal coupled to the threshold voltage, a second input terminal coupled to a predetermined threshold voltage, and an output terminal, for selectively outputting the threshold voltage or the predetermined threshold voltage via the output terminal;
a slicer, coupled to the signal reception terminal and the output terminal of the multiplexer, for slicing the composite video signal to extract a synchronization signal in the composite video signal according to the threshold voltage or the predetermined threshold voltage; and
a signal output terminal, coupled to the slicer, for outputting the extracted synchronization signal.

24. The synchronization signal extraction device of claim 23, wherein the multiplexer outputs the predetermined threshold voltage via the output terminal when the synchronization signal extraction device is initiated.

25. The synchronization signal extraction device of claim 23, wherein the composite video signal comprises a video signal interval and a synchronization signal interval for carrying a video signal and the synchronization signal, respectively.

26. The synchronization signal extraction device of claim 25, wherein the first characteristic level is a black level of the video signal interval.

27. The synchronization signal extraction device of claim 25, wherein the first characteristic level is a lowest level of the synchronization signal interval.
